(19) United States
(12) Patent Application Publication
(10) Pub. No.: US 2006/0292541 A1
(43) Pub. Date: Dec. 28, 2006

(54) APPARATUS FOR FORMING A SELECT TALENT GROUP AND METHOD OF FORMING THE SAME

(76) Inventor: David M. Ehmann, Lake George, NY (US)

Correspondence Address: GFD PATENTS, LLC, P.O. BOX 752, CLIFTON PARK, NY, 12065, US

(21) Appl. No.: 11/421,480

(22) Filed: Jun. 1, 2006

Related U.S. Application Data
(63) Continuation-in-part of application No. 11/142,175, filed on Jun. 1, 2005.

(51) Int. Cl. G09B 3/00

(52) U.S. Cl. 434/350

(57) ABSTRACT

An apparatus and method for analyzing selection criteria for forming a Select Talent Group. The apparatus includes an input device operably coupled to a Select Talent Group Selector having a computing circuit for computing scores of the individuals in the at least two talent groups based on the selection criteria and audition information. The apparatus includes a database operably coupled to the Select Talent Group Selector. The apparatus includes an output device, having displays listing the output of the output device. The method for forming a Select Talent Group, comprising: selecting subject matter to be performed from a data base; instructing each of a plurality of talent groups to perform the subject matter; forming the Select Talent Group by selecting the Select Talent Group from the plurality of talent groups competing in a first contest, wherein the selection of the Select Talent Group is based on predetermined criteria.

The present patent application is a continuation-in-part application claiming priority from non-provisional application S/N 11/142,175 (filed 06/01/2005 and titled “APPARATUS FOR FORMING A SELECT TALENT GROUP AND METHOD OF FORMING THE SAME”).

### FIELD OF USE

The present invention relates generally to an apparatus and method for recruiting talent and more particularly to an apparatus and method for forming a Select Talent Group from at least two talent groups.

### BACKGROUND

Many industries, such as the Entertainment and Sports Industries, recruit people for particular careers; actors and actresses for shows, athletes for sports teams and the like. Recruiting can be a complex process that may include auditioning or interviewing candidates by judges or experts in a particular area of talent.

There is a need for an improved system of recruitment that provides flexibility in handling the information gathered during the recruitment process.

### SUMMARY OF THE INVENTION

A first aspect of the present invention provides a method for forming a Select Talent Group, comprising: forming a plurality of qualifying talent groups by selecting the plurality of qualifying talent groups from all talent groups competing in a first contest, wherein the selecting is based on predetermined criteria; selecting by live audience voting a first narrowed plurality of qualifying talent groups from the plurality of qualifying talent groups; selecting by voting a second narrowed plurality of qualified talent groups from the first narrowed plurality of qualifying talent groups, wherein the individuals having the least votes are voted out until a standout member remains; and forming the Select Talent Group by selecting by voting the Select Talent Group from the second narrowed plurality of qualified talent groups, wherein the selecting is based on voting, wherein the individuals having the least votes are voted out and replaced by a standout member.

A second aspect of the present invention provides a method for forming a Select Talent Group, comprising: selecting subject matter to be performed from a data base, said data base comprising subject matter selected from the group consisting of a soundtrack from a movie, a soundtrack from a song, poetry, and text from a written work; instructing each of a plurality of talent groups to perform the subject matter; and forming the Select Talent Group by selecting the Select Talent Group from the plurality of talent groups competing in a first contest, wherein the selection of the Select Talent Group is based on predetermined criteria.

### BRIEF DESCRIPTION OF THE FIGURES

FIG. 1 is a flow sheet depicting a method for forming a Select Talent Group, in accordance with embodiments of the present invention;

FIG. 2 is a diagram of a worksheet that may be used to identify an area(s) of talent that may categorize the Select Talent Group to be formed, in accordance with embodiments of the present invention;

FIG. 3 is a diagram of a worksheet for selecting the at least one individual from a talent group for membership in the Select Talent Group, in accordance with embodiments of the present invention;

FIG. 4 is a schematic block diagram of an apparatus for analyzing audition information for forming Select Talent Groups in accordance with embodiments of the present invention consisting of a general-purpose computer operably connected to a satellite or cable provider;

FIG. 5 is a flow diagram for a method for forming a Select Talent Group, in accordance with embodiments of the present invention; and

FIG. 6 is a flow diagram for a method for forming a Select Talent Group, in accordance with embodiments of the present invention

### DETAILED DESCRIPTION OF THE EMBODIMENTS

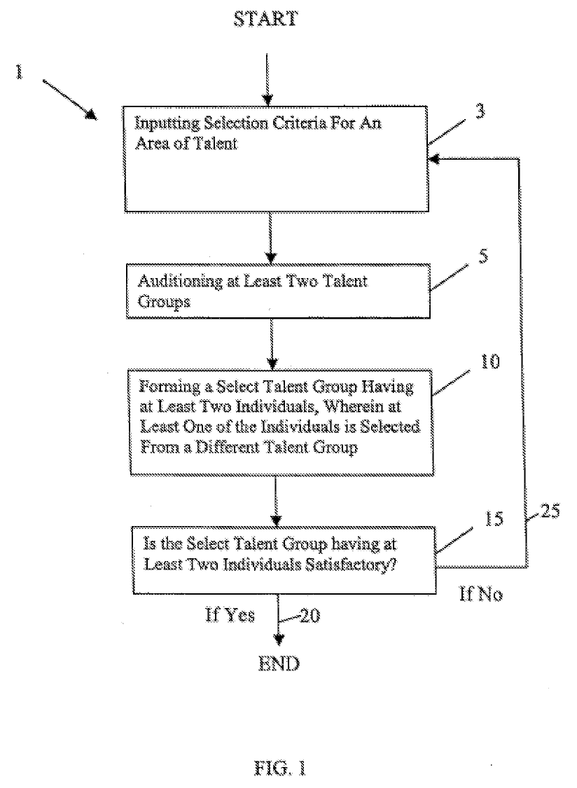

FIG. 1 depicts a method 1 for forming a Select Talent Group having at least two individuals comprising: step 3, inputting selection criteria for an area of talent; step 5, auditioning at least two talent groups; step 10, forming the Select Talent Group having at least two individuals, wherein at least one of the individuals is selected from a different talent group; and step 15, determining if the Select Talent Group having at least two individuals is satisfactory. Step 20 of method 1 then directs that if the response to step 15 of method 1 is “yes”, the Select Talent Group having at least two individuals is satisfactory, and method 1 is complete. Step 25 of method 1, however, directs that if the response to step 15 of method 1 is “no”, the Select Talent Group having at least two individuals is not satisfactory, and the method 1 may feedback to step 3 of method 1 to further refine the Select Talent Group.

The selection criteria, as in step 3 of method 1, may represent the factors by which an individual is chosen from an individual or group performance to be in a talent group. Selection criteria, as in step 3 of method 1, by which talents are evaluated may include individual and overall talent, musicianship, individual personality, showmanship, stage presence, audience involvement, technical ability, originality, sound quality, and combinations thereof.

An area of talent, as in step 3 of method 1, may include the ability of an individual or group of individuals to perform, act, or entertain in a variety of situations, such as singing, dancing, acting, comedy, improvisation, playing of musical instruments, and combinations thereof. Hereinafter, talent or talented, is defined as a marked innate ability, as for artistic accomplishment, a natural endowment or ability of a superior quality, or person or group of people having such ability. Auditioning, as in step 5 of method 1, may be the step by which at least two talent groups are auditioned. Hereinafter, “auditioning” or “auditioned” is defined as: to evaluate (a person) in a trial performance, as by an actor, dancer, or musician, or to take part in a trial performance; or to demonstrate suitability or skill. Auditioning, as in step 5 of method 1, may be the step by which a talent group is evaluated relative to pre-established selection criteria for inclusion in a Select Talent Group. A talent group, as in step 5 of method 1, may be an individual or group of individuals capable of performing in a skillful manner such as in competitions, pageants, talent searches, open performances, or compilations of compact disc or video performances (including singing, acting, comedy, improvisation, individual referrals, or playing of musical instruments) by individuals or groups of individuals. Auditioning, as in step 5 of method 1, is therefore a process by which talent groups display their specific talent(s).

Forming the Select Talent Group having at least two individuals, as in step 10 of method 1, may result from the use of the selection criteria, as described in discussion of step 3 of method 1, supra. In the forming the Select Talent Group having at least two individuals, step 10, at least one of the individuals is selected from a talent group other than the talent group of another of the at least two individuals.

Selection criteria, as in step 3 of the method 1, may be weighted, wherein selection criteria that has been determined to be necessary for success of the Select Talent Group is given priority by assigning a weighting factor (W) to it. The weighting factor (W) may be an integer from about 1 to about 10. The selection criteria include style, sound character, sound quality, presence, showmanship, technical ability, and combinations thereof. Weighting selection, i.e. assigning more or less emphasis, may be done by multiplying a rating for the selection criteria by the weighting factor (W), such that the Select Talent Group formed exhibits attributes specified by the selection criteria. Forming the Select Talent Group, as in step 10 of the method 1, may utilize calculating a weighted score (S) for each individual in the talent groups, wherein the weighted score (S) in each selection criteria may be equal to a product of the weight (W) of the selection criteria multiplied by a rating (R) of the at least one individual based on how well the individual performed in accordance with the selection criteria. S=W (×) R. The individuals selected for the Select Talent Group are those that achieve the highest weighted scores (S). Select Talent Groups may therefore vary in their style, sound character, sound quality, presence, showmanship, technical ability, and combinations thereof.

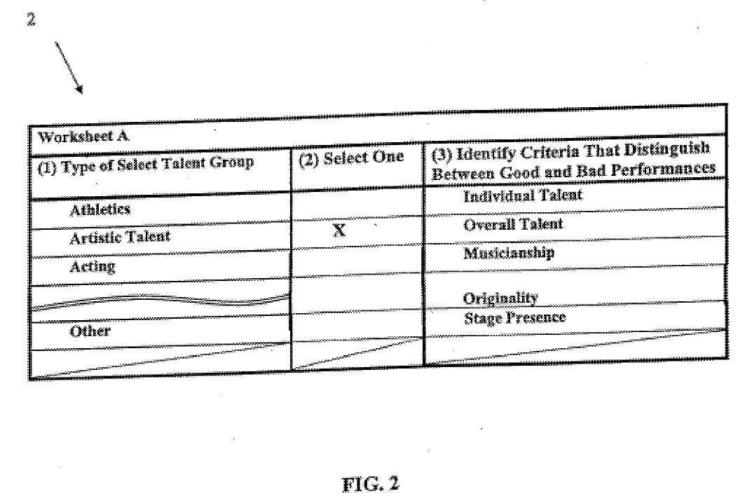

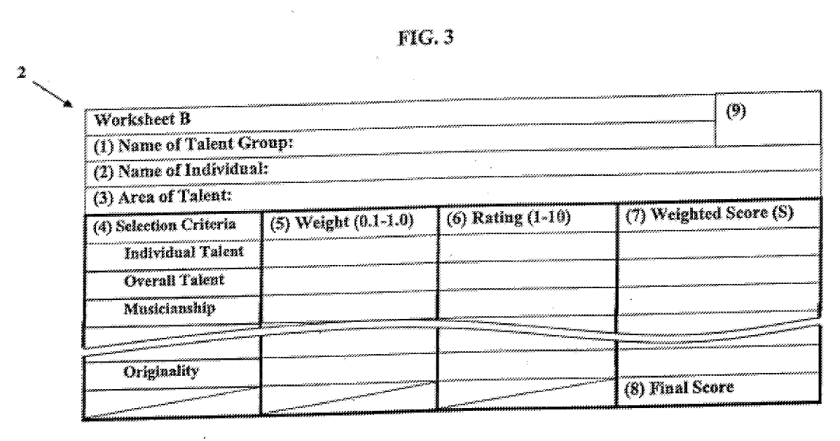

FIGS. 2-3 depict an apparatus 2 for analyzing audition information for forming a Select Talent Group comprising: at least one worksheet, A, B, for listing selection criteria for an area of talent and audition information and for computing scores of at least two individuals from at least two talent groups, wherein at least one of the at least two individuals is selected from a talent group other than the talent group of another of the at least two individuals based on the selection criteria and audition information.

FIG. 2 is a diagram of a worksheet A that may be used to identify the type of Select Talent Group desired and to establish the criteria specific to that talent group that distinguish a good performance from a bad performance. The worksheet A of FIG. 2 comprises three Fields (1-3), in which a user of the method 1, as depicted in FIG. 1 and described herein, may specify the type of Select Talent Group to be formed. Field (1) of the FIG. 2 worksheet A, “Type of Select Talent Group”, provides the user with common categories of Select Talent Groups to choose from, such as Athletics, Artistic Talent, Acting and Comedy. Field (2) of the FIG. 2 worksheet A allows the user to place a mark, such as a “√” or an “x”, in the field adjacent to the category of Select Talent Group in Field (1) that the user wishes to create. When the Field (1) Select Talent Group category has been identified, the worksheet A of FIG. 2 allows the user to further specify a Select Talent Group subcategory. For example, if the user places a mark in Field (2) adjacent to the Field (1) Select Talent Group category “Athletics”, the worksheet A of FIG. 2 allows the user to enter a specific type of athletics, such as “Soccer”, “Baseball”, or “Basketball”, directly below the Field (1) “Athletics” category. In the event that the common categories of Select Talent Groups provided in Field (1) of the FIG. 2 worksheet A fail to reflect the type of Select Talent Group that the user wishes to create, the user may place a mark in Field (2) adjacent to the Field (1) category “Other”, and then indicate the desired Select Talent Group category or subcategory in Field (1) directly below the “Other” designation.

Field (3) of the FIG. 2 worksheet A, “Identify Criteria That Distinguish Between Good and Bad Performers”, allows the user to enter selection criteria (as in step 3 of method 1 supra) specific to the “Type of Select Talent Group” identified in Field (1) of FIG. 2. Listing characteristics in Field (3) of the FIG. 2 worksheet A that distinguish between good and bad performances of the Select Talent Group specified in Field (1) allows the user to establish the selection criteria according to which individuals exhibiting desired traits or talents may be selected, while those exhibiting undesired traits may be eliminated. For example, if “Athletics” was selected in Field (1) of FIG. 2, the user may enter “Coordination”, “Speed”, and “Strength” as good criteria, and “Clumsiness”, and “Selfishness” as bad criteria. The completed worksheet A of FIG. 2, indicating the “Type of Select Talent Group”, Field (1), and “Identify Criteria That Distinguish Between Good and Bad Performers”, Field (3), may then be inputted or applied to the worksheet B of FIG. 3.

FIG. 3 is a diagram of a worksheet B for forming a Select Talent Group having at least two individuals, wherein at least one of the individuals is selected from a talent group other than the talent group another of the at least two individuals, comprising Fields 1-9. In Field (1), “Name of Talent Group”, the user is instructed to enter the name of the talent group that may be auditioning. In Field (2), “Name of Individual”, the user is instructed to enter the name of the at least one individual in the talent group that may be auditioning. In Field (3), “Type of Select Talent Group”, the user may enter the “Type of Select Talent Group” from Field (1) of the worksheet A depicted in FIG. 2 and described in associated text supra, for the Select Talent Group that is to be formed from the at least one individual in the talent group that may be auditioning. In Field (4), “Selection Criteria”, the user may enter “Identify Criteria That Distinguish Between Good and Bad Performers” from Field (3) of worksheet A depicted in FIG. 2, and described herein. In Field (5), “Weight (0.1-1.0)”, the user may designate a weighting factor that may be proportional to an importance that the user attributes to each of the “Selection Criteria” in the Field (4) of the worksheet B for selecting the at least one individual from a talent group for membership in the Select Talent Group. In Field (6), “Rating (1-10)”, the user may designate a rating for the at least one individual based on how well the individual performed in accordance with the selection criteria. In Field (7), the user may calculate the “Weighted Score” (S) for the at least one individual by multiplying the “Weight” from Field (5) and the “Rating” from Field (6). In Field (8), “Final Score”, the user may add the “Weighted Scores” (S) to arrive at a “Final Score” for the at least one individual who may be auditioning for membership in the Select Talent Group.

In one embodiment of the apparatus 2, for analyzing audition information for forming a select talent group, the Field (8) for tabulating the “Final Score” for the worksheet B may include a symbol that designates whether the Final Score lies within ratings of “excellent”, “above average”, “average”, “poor” or “failure”. The numerical range for an “excellent” may be a score greater than 90% based on a total number of possible points for weighted scores for each selection criteria of an area of talent. The numerical range for “above average” may be from about 80%-90% based on the total number of possible points for the weighted scores for each selection criteria of the area of talent. The numerical range for “average” may be from about 70%-80% based on the total number of possible points for the weighted scores for each selection criteria of the area of talent. The numerical range for “poor” may be from about 60%-70% based on the total number of possible points for the weighted scores for each selection criteria of the area of talent. The numerical range for “failure” may be below 60% based on the total number of possible points for the weighted scores for each selection criteria of the area of talent. The symbol may be a picture, a star, a colored tab or the like.

To assist the user in the selection process, the symbol designating the degree of excellence of the individual's rating may be indicated on the worksheet B of FIG. 3 with a color-coded system. For example, Field (9) of worksheet B may have a number of adhesive tabs in one corner (such as the upper right-hand corner), which when removed, reveal an underlying colored bar. Based on the “Final Score” of a given FIG. 3 worksheet B, the user may remove the adhesive tab, thereby revealing a given color bar. The user may therefore reveal a “Red” bar on the FIG. 3 worksheet B to designate a high “Final Score” of an individual with talent, and a “Blue” bar on the FIG. 3 worksheet B to designate a low “Final Score” of the individual with talent. By providing the worksheet B of FIG. 3 with a number of these adhesive tabs concealing colored bars, a user may readily scan the completed worksheets B to identify the at least two individuals with talent to include in the Select Talent Group. 100231 Generally, the method 1 described herein, using the worksheets A, B of apparatus 2, illustrated in FIGS. 2 and 3 and described supra, may be practiced with a general-purpose computer and the method 1 may be coded as a set of instructions on removable or hard media for use by the general-purpose computer.

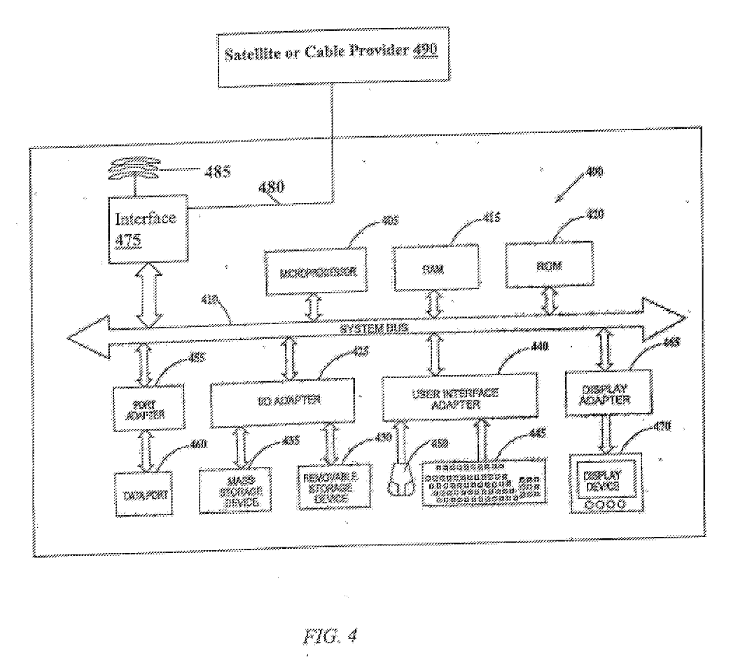

FIG. 4 is a diagram of an apparatus 3 for analyzing audition information, comprising: a general-purpose computer system 400. The general-purpose computer 400 includes an input device 445 for inputting the selection criteria for an area of talent and audition information into the general-purpose computer 400. The general-purpose computer includes a microprocessor 405 for computing scores of the at least two individuals from the at least two talent groups, wherein at least one of the individuals is selected from a talent group other than the talent group of another of the at least two individuals based on the selection criteria and audition information. The general-purpose computer 400 includes a database, such as a mass storage device 435 and/or a removable storage device 430, wherein the database may be operably coupled to the microprocessor 405 for storage of the computed scores, the selection criteria and audition information, wherein the audition information may be selected from a satellite or cable provider 490, CDs, tapes, live performances and combinations thereof. The general-purpose computer 400 may include an output device, such as a display device 470 having displays listing the audition information and scores.

Computer system 400 has at least one microprocessor or central processing unit (CPU) 405. CPU 405 is interconnected via a system bus 410 to a random access memory (RAM) 415, a read-only memory (ROM) 420, an interface 475 for interfacing with a satellite or cable provider 490 either directly via cable 480 or wirelessly via antenna 485, an input/output (I/O) adapter 425 for connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a monitor 470.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of monitors include cathode-ray tubes (CRT) and liquid crystal displays (LCD). A computer program with an appropriate application interface may be created by one of skill in the art and stored on the system or a data and/or program storage device to simplify the practicing of this invention. In operation, information for the computer program created to run the present invention is loaded on the appropriate removable data and/or program storage device 430, fed through data port 460 or typed in using keyboard 445.

The display device 470 of the FIG. 4 apparatus 3 may display the worksheets A, B of FIGS. 2 and 3 digitally, allowing a user may to input data into the respective Fields of said worksheets using the keyboard 445. The computer system 400 may be a personal computer such as a desktop computer, or a smaller computer such as a laptop computer, cell-phone, or other portable device having a display device 470 such as a Palm-Pilot, Personal Digital Assistant (PDA), or Blackberry. The computer system 400 may therefore be used to evaluate talent groups for forming a Select Talent Group at a wide variety of locations, such as the home, workplace, the set of a television program, a production studio, or the location of any type of performance, i.e. concerts, plays, movies, sporting events and combinations thereof. The individual using the computer system 400 may be a judge, panel of judges, or a member of an audience, such as a reality television, studio, or home viewing audience.

In addition to allowing a user to input data specific to the type of Select Talent Group desired, the computer system 400 may also permit the user to retrieve previously filed worksheets A, B by searching the mass storage device 435 or the removable storage device 430 for ratings attributed to auditioned or interviewed candidates, selection criteria for the Area(s) of Talent, and personal audition information for members of the at least two talent groups, using a key word search in any of the Fields of the worksheets A, B.

The computer system 400 permits information entered into the Fields of the digital worksheets to be processed automatically. Field (1) of the FIG. 2 worksheet A, designated A_{x,y} (wherein x and y may be any positive integer: x=1, 2, 3, . . . i, and y=1, 2, 3, . . . j), allows the user to identify the “Type of Select Talent Group”, wherein x represents the general category of Select Talent Group and y represents the specific category of Select Talent Group within that general category. For example, to create a “Soccer” Select Talent Group, the Field (1) designation may be A_{x=,y=1}, wherein “x=1” represents the general category “Athletics” and “y=1” represents the specific category “Soccer”. Likewise, to designate a “Baseball” Select Talent Group, the Field (1) designation may be A_{x=1,y=2}, wherein “x=1” again represents the general category “Athletics” and “y=2” represents the specific category “Baseball”. To create a Select Talent Group of a general category other than “Athletics”, for example “Artistic Talent”, the user's Field (1) designation may be represented by A_{x=2,y=1}, wherein “x=2” represents “Artistic Talent” and “y=1” represents a subcategory of artistic talent such as “Singing”. The Field (1) designation A_{x,y} thereby allows a user to designate an unlimited number of general categories of Select Talent Groups and further designate an unlimited number of specific categories of Select Talent Groups within that general category.

Having identified the “Type of Select Talent Group” in Field (1), the computer system 400 may then apply the A_{x,y} designation to Field (2) of the FIG. 2 worksheet A to “Identify Criteria That Distinguish Between Good and Bad Performances” with the designation A_{x,y}B_{z} (wherein z=1, 2, 3, . . . k). With A_{x,y} properly designated, Field (2) allows the user to list criteria that distinguish between good and bad performances of a given Select Talent Group, with each criteria receiving a specific identifier. For example, if the user has decided to create a “Soccer” Select Talent Group (A_{x=1,y=1}), criteria entered into Field (2) to distinguish between a good and bad performance may include “Speed” (A_{x=1,y=1} B_{z=1}), “Footwork” (A_{x=1,y=1} B_{z=2}) and “Stamina” (A_{x=1,y=1} B_{z=3}). Since B may be any positive integer, Field (2) allows the user to list unlimited criteria by which individuals may be evaluated for inclusion in the Select Talent Group. The flexibility provided by Field (2) of the FIG. 2 worksheet A may allow the user to form Select Talent Groups ranging from very general, by listing a relatively small number of criteria, to very specific, by listing numerous criteria. The feedback loop 25 as in method 1 may then allow the user to modify and/or update the Select Talent Group by adding or removing criteria from Field (2) of the FIG. 2 worksheet A if the user is not satisfied with the Select Talent Group, or for example if new individuals with talent become available for consideration.

As described above, with Fields (1) and (2) of the FIG. 2 worksheet A complete, the computer system 400 may apply the data within those fields to the respective Fields of the FIG. 3 worksheet B, allowing the user to proceed with the evaluation process. The worksheet B of FIG. 3 is then utilized by the user to evaluate the at least two individuals to be included in the Select Talent Group based on the criteria designated in the worksheet A of FIG. 2. The computer system 400 may calculate the “Weighted Score” (S) as the product of the “Weight” (W) of Field (5) and the “Rating” (R) of Field (6) as described in step 3 of method 1 supra, and enter the resulting value in Field (7) for each selection criteria. The computer system 400 may then calculate the “Final Score” that results from the sum of the “Weighted Scores” (S) and enter that value in Field (8).

The interface 475 of the computer system 400 of the apparatus 3 for interfacing with a satellite or cable provider 490 either directly via cable 480 or wirelessly via antenna 485 may allow a variety of interactive applications in which multiple users apply the method 1 of FIG. 1 to contribute to the formation of Select Talent Groups. For example, a plurality of users, such as a home audience or studio audience, may use the method 1 and apparatus 3 of the present invention to evaluate a pool of individual talent groups to determine which individuals with talent are chosen for a Select Talent Group. The resulting Select Talent Group may be continually modified, as for example in future episodes of a television program, to form new Select Talent Groups as more talent groups are added to a pool of talent groups. In other embodiments a plurality of users, such as home audience or studio audience, may use the method 1 and apparatus 3 of the present invention to create individual Select Talent Groups that could then be evaluated by the audience to decide which individually created Select Talent Group is the most talented or most closely reflects predetermined traits, characteristics, or levels of skill, and combinations thereof. The ability of the method 1 and apparatus 3 of the present invention to be applied in this interactive way may be extremely useful for any area of talent. For example, the continuing popularity of reality television programs (i.e. Survivor) and viewer-based talent competitions (i.e. American Idol) may gain popularity as the audience becomes more involved in the selection and formation process. Similarly, the method 1 and apparatus 3 of the present invention may be useful in an area of talent such as athletics by allowing a user, such as a sports fan, scout, or team owner, to evaluate individual athletes during their participation in a sporting event to determine if they might be a valuable asset to a given team based on their individual talent and the current needs of that organization.

### EXAMPLE 1

### FOR THOSE ABOUT TO ROCK

As the television commercial at 7:59 pm fades to black, you begin to hear a rock and roll guitar lick. It is a great riff, not to fast or complex, but truly tasteful. It is the beginning of the AC/DC classic “For those about to rock (we salute you).” After all, the bands on this show do rock, but one member from each is about to join into the first wave of the next generation of immortal rock bands. And so, as the first five seconds of the riff plays, the scene fades in from black to a stadium sized rock concert stage, with incredible top notch equipment, and a wall of speakers, and drums all around, it's a true musicians wonderland, but it is empty of people and only back lit for shadow. At 10 seconds the kick drum starts. With every beat, a new image of a different immortal rock band flashes, and slowly the stage lights rise. At around 20 seconds, a one bar build up of thunderous proportions, leads into stage bombs and pyrotechnics, the likes of which haven't been seen before, but all to a stage with no musicians. This is when, as the theme song plays, on the screen fades in “Improv Records Presents . . . Fades out . . . Fades into . . . For Those About To Rock . . . and then into all the usual opening credits.

For those about to rock is a television show that narrows a plurality of talent groups to form a first narrowed qualifying talent groups, e.g., 10 eager and raw unsigned bands, and through judges, scoring and audience/viewer participation further narrows the first narrowed qualifying talent group to a second and so forth narrowed qualifying talent group until all but one standout member of each plurality of talent groups remains. The standout members then compete with and against each other to form the Select Talent Group or winning band.

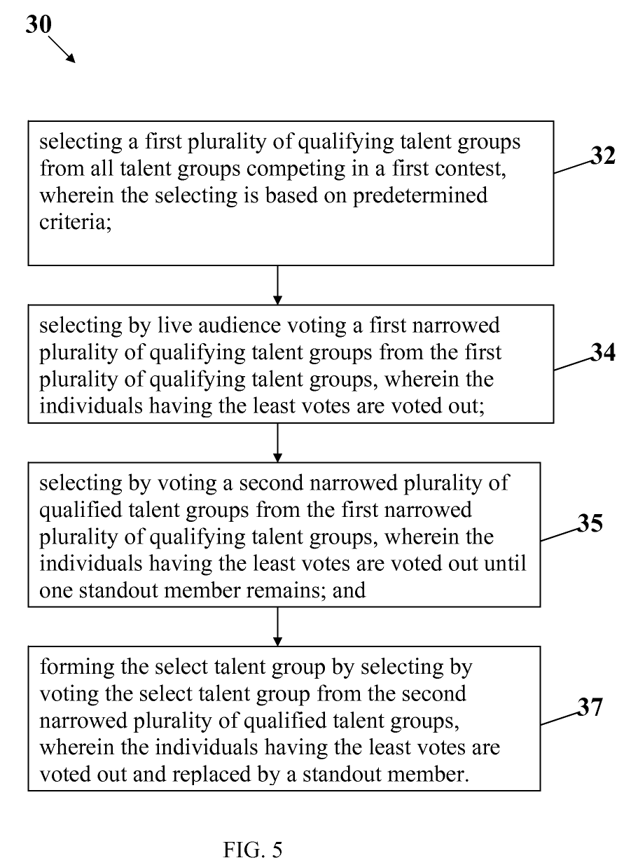

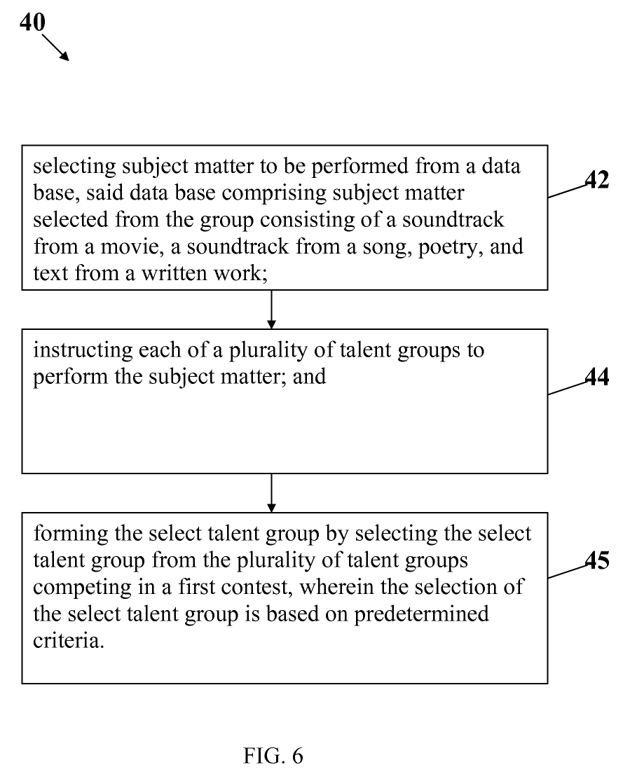

Forming the Select Talent Group (Example 1, above, and the methods 30 and 40, depicted in FIGS. 5 and 6 and described in associated text) is based on the concept that a successful TV show must have the “hook” and conflicting personalities and agendas, i.e. mixed with some type of tension or stress and the knowledge that the viewer can directly affect the outcome.

Almost anyone who has ever been in a band knows that the chance of becoming successful in the music business is slim to none. It truly is one in a million bands make it. It is also fair to say that at one time or another, one member of the band thinks they standout, or carry the band in some way, or that certain members are holding the band back. All bands, and individual band members want to standout, to be seen, heard, and have their ego's fed.

First, all the usual local band searches and battles. All of these performances are taped for blooper footage. Next, narrowing down to the 20 or so best bands, according to our criteria for the first show. Then those bands come to the TV studio for the further narrowing down to 10 in front of a live audience while being taped for footage for the live show.

Once the 10 best are decided upon, camera crews will follow them around for 14 days, recording virtually everything they do for footage. The 10 compete live on TV and are judged, not only by the audience, but also by a panel of celebrity judges, and by on the spot video phone critique from some of the truest superstars of rock and roll. Narrowing to 5. Each of the 5 bands will play live on TV, then members get voted out and replaced with the more standout members of the 5 bands that lost previous, but were picked as standout members. In the event that an instruments position has no standout member, footage from previous shows can be used to find or to bring back a member that was passed over or that's band had lost. Hereinafter, “standout member” or “standout” is defined as one that is conspicuous by virtue of excellence or superiority.

In addition to the weights set forth as criteria there will be a panel of music celebrity judges, audience via phone and Internet, and of course the superstars of rock and roll. The judges will receive 51% of the voting power, and the audience receives 49%.

The superstars will have the power to over-rule any one decision per show or bring back a previous member, thus resulting in a re-match. A successful TV show generates plenty of ad revenue.

The music side generates revenue again and again. As the bands change members, so do the bands CDs. The same five bands could potentially be twenty-five different bands. There is also mass merchandising, Internet sales, and live venues.

The methods 30 and 40 may be used to create the next generation of “super groups”, in every genre, and in the process of doing so, generate hundreds of millions of dollars in revenue. The methods 30 and 40 provide a way to find all of the unsigned bands that have what it takes to sell, but cannot be discovered. The methods 30 and 40 provide a way to put together bands that are guaranteed to be what the public is looking for, and at the same time sell records from the bands that are not. The methods 30 and 40 provide a way to sell music without any risk of signing an artist, spending hundreds of thousands of dollars recording and promoting, only to find that it was not profitable. The methods 30 and 40 provide a way to pre-determine what will sell . . . . And sell what ordinarily would not.

FIG. 5 depicts a method 30 for forming a select talent group. The method 30 for forming the select talent group includes a step 32: selecting a plurality of qualifying talent groups from all talent groups competing in a first contest, wherein the selecting is based on predetermined criteria. Hereinafter, a “contest” means a competition between contestants such as the talent groups and individuals in the talent groups in which the contestants compete for a numerical majority of votes awarded by judges, a live audience, a panel of celebrity judges or by an on the spot video phone critique by superstars of rock and roll to those contestants that substantially achieve or nearly achieve the predetermined criteria associated with membership in the Select Talent Group.

The method 30 includes a step 34: selecting by live audience voting a first narrowed plurality of qualifying talent groups from the plurality of qualifying talent groups, wherein the individuals having the least votes are voted out. The method 30 includes a step 35: selecting by voting a second narrowed plurality of qualified talent groups from the first narrowed plurality of qualifying talent groups, wherein the individuals having the least votes are voted out until one standout member remains. The method 30 includes a step 37: forming the select talent group by selecting by voting the select talent group from the second narrowed plurality of qualified talent groups, wherein the individuals having the least votes are voted out and replaced by a standout member.

In an embodiment, voting in the method 30 includes voting by a live audience, a panel of celebrity judges or by an on the spot video phone critique by superstars of rock and roll.

In an embodiment, the standout member who replaces individuals who have been voted out of the Select Talent Group of the method 30 is selected from standout members that were voted out of the first or second narrowed plurality of qualified talent groups.

In an embodiment, the judges'vote of the method 30 has 51% weight and the audience's vote has 49% weight.

In an embodiment, the talent group of the method 30 may become part of a reality television show.

In an embodiment of the method 30, when the first competition is taped, blooper footage is edited out, and the selections are based on viewing the edited tape and the standout member is selected from the edited tape.

In an embodiment, the plurality of qualifying talent groups of the method 30 is at least 20 groups. Alternatively, the plurality of qualifying talent groups is at least 10 groups. Alternatively, the plurality of qualifying talent groups is at least 5 groups. The number of individuals in the talent groups of the method 30 is at least one.

In the method 30, the method for forming a select talent group may further comprise weighting the selection criteria for the area of talent based on a relevance of that talent to a specification of the select talent group.

In the method 30, the method for forming a select talent group may further comprise rating each individual of the talent group in accordance with the selection criteria.

In the method 30, the method for forming a select talent group may further comprise calculating a score resulting from multiplying the rating by the weighting.

In the method 30, the method for forming a select talent group may further comprise forming the select talent group, wherein selection of each individual in the select talent group is based on the calculated score.

In an embodiment of the method 30, an audience uses an electronic device to submit their selection criteria to a real time database via satellite to determine the talent group created from a pool of individual talent groups.

In an embodiment of the method 30, the audience members establish selection criteria to create their own talent groups; said talent groups are transmitted to the real time database via satellite; and said talent groups are voted on by said audience to determine which individually created talent group is most talented.

In an embodiment, the selection criteria for the area of talent are presented in individual fields on a worksheet. The worksheet may be in electronic or digital form and the selection criteria may be revised by the audience, judges or superstars doing the evaluation by adding or deleting selection criteria.

FIG. 6 depicts a method 40 for forming a select talent group. The method 40 includes a step 42: selecting subject matter to be performed from a data base, said data base comprising subject matter selected from the group consisting of a soundtrack from a movie, a soundtrack from a song, poetry and text from a written work. The method 40 includes a step 44: instructing each of a plurality of talent groups to perform the subject matter, e.g. to sing or play a soundtrack with a musical instrument such as a percussion instrument, a bass or a guitar. The method 40 includes a step 45: forming the select talent group by selecting the select talent group from the plurality of talent groups competing in a first contest, wherein the selection of the select talent group is based on predetermined criteria.

In an embodiment of the method 40, the subject matter is music performed on instruments selected from the group of instruments consisting of a bass instrument, a percussion instrument, and a guitar.

In an embodiment, the method 30 and the method 40 for forming the Select Talent Group is a game in which a plurality of participants in the game compete in a first contest to form the Select Talent Group having the highest score according to the predetermined selection criteria.

In an embodiment of the method 40, the subject matter is selected from the group consisting of audition lines, compilations of video performances, compilations of CD performances, compositions from singing groups, compositions from instrumental groups, compositions from individual musicians, and compositions from individual referrals.

In an embodiment of the method 30 and the method 40, the predetermined criteria for the area of talent consists of: individual talent, overall talent, musicianship, individual personality, showmanship, stage presence, audience involvement, technical ability, originality, sound quality, improvisation skills, and combinations thereof.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. A method for forming a select talent group, comprising:
forming a plurality of qualifying talent groups by selecting the plurality of qualifying talent groups from all talent groups competing in a first contest, wherein the selecting is based on predetermined criteria;
selecting by live audience voting a first narrowed plurality of qualifying talent groups from the plurality of qualifying talent groups;
selecting by voting a second narrowed plurality of qualified talent groups from the first narrowed plurality of qualifying talent groups, wherein the individuals having the least votes are voted out until a standout member remains; and
forming the select talent group by selecting by voting the select talent group from the second narrowed plurality of qualified talent groups, wherein the selecting is based on voting, wherein the individuals having the least votes are voted out and replaced by a standout member.

2. The method of claim 1, wherein the first competition is taped, blooper footage is edited out, and the selections are based on viewing the edited tape and the standout member is selected from the edited tape.

3. The method of claim 1, wherein the plurality of qualifying talent groups is at least 20.

4. The method of claim 1, wherein the first narrowed plurality of qualified talent groups is at least 10.

5. The method of claim 1, wherein the second narrowed plurality of qualified talent groups is at least 5.

6. The method of claim 1, wherein the standout member who replaces individuals who have been voted out of the Select Talent Group is selected from standout members that were voted out of the first or second narrowed plurality of qualified talent groups.

7. The method of claim 1, wherein the judges' vote has 51% weight and the audience's vote has 49% weight.

8. The method of claim 1, wherein said talent group may become part of a reality television show.

9. The method of claim 1, wherein an audience uses an electronic device to submit their selection criteria to a real time database via satellite to determine the talent group created from a pool of individual talent groups.

10. The method of claim 9, wherein audience members establish selection criteria to create their own talent groups;
said talent groups are transmitted to the real time database via satellite; and
said talent groups are voted on by said audience to determine which individually created talent group is most talented.

11. The method of claim 10, wherein said selection criteria for the area of talent are presented in individual fields on a worksheet.

12. The method of claim 11, wherein said worksheet is digital.

13. The method of claim 11, wherein said worksheet may be revised by deleting selection criteria for areas of talent.

14. The method of claim 11, wherein said worksheet may be revised by adding selection criteria for areas of talent.

15. The method of claim 11, wherein forming the select talent group further comprises:
weighting the selection criteria for the area of talent based on a relevance of that talent to a specification of the select talent group;
rating each individual of the talent group in accordance with the selection criteria;
calculating a score resulting from multiplying the rating by the weighting; and
forming the select talent group, wherein selection of each individual in the select talent group is based on the calculated score.

16. A method for forming a Select Talent Group, comprising:
selecting subject matter to be performed from a data base, said data base comprising subject matter selected from the group consisting of a soundtrack from a movie, a soundtrack from a song, poetry, and text from a written work;
instructing each of a plurality of talent groups to perform the subject matter; and
forming the select talent group by selecting the Select Talent Group from the plurality of talent groups competing in a first contest, wherein the selection of the Select Talent Group is based on predetermined criteria.

17. The method of claim 16, wherein the subject matter is music performed on instruments selected from the group of instruments consisting of a bass instrument, a percussion instrument, and a guitar.

18. The method of claim 16, wherein forming the Select Talent Group is a game in which a plurality of participants in the game compete to form the Select Talent Group having the highest score according to the predetermined selection criteria.

19. The method of claim 16, wherein the subject matter is selected from the group consisting of audition lines, compilations of video performances, compilations of CD performances, compositions from singing groups, compositions from instrumental groups, compositions from individual musicians, and compositions from individual referrals.

20. The method of claim 16, wherein the predetermined criteria for the area of talent consists of: individual talent, overall talent, musicianship, individual personality, showmanship, stage presence, audience involvement, technical ability, originality, sound quality, improvisation skills, and combinations thereof.
